(19) United States
(12) Patent Application Publication
(10) Pub. No.: US 2007/0037129 A1
(43) Pub. Date: Feb. 15, 2007

(54) Finger angel craft kit and personal identification system and device

(76) Inventor: Brandee Beth Boyer, St. Simons Island, GA (US)

Correspondence Address: Brandee Beth Boyer, 205 Pelican Place, St. Simons Island, GA, 31522, US

(21) Appl. No.: 11/451,002

(22) Filed: Jun. 12, 2006

Related U.S. Application Data
(60) Provisional application No. 60/595,589, filed on Jul. 18, 2005.

(51) Int. Cl. G09B 11/00; B42D 15/00; G09B 19/00

(52) U.S. Cl. 434/81; 434/155; 283/78

(57) ABSTRACT

A self-contained, artistically creative craft kit, wherein a child's fingerprints are incorporated into a base drawing and the drawing is personalized with the child's name, wherein a transparent box is initially utilized to contain the craft components and subsequently to perform as a display frame, wherein a ten-print fingerprint card is stored therein, and wherein DNA source material, in the form of a hair sample, is securely retained, along with personal data, and a photo, on an identification card also stored therein.

### CROSS-REFERENCE TO RELATED APPLICATION

To the full extent permitted by law, the present Patent Application claims priority to and the Benefit of U.S. Provisional application entitled “Finger Print Angel,” filed on Jul. 18, 2005, Brandee Beth Boyer, having assigned Ser. No. 60/595,589.

### FIELD OF THE INVENTION

The present invention relates generally to craft devices, and more particularly, to a Personal identification system and device, wherein a pre-packaged craft provides a fun activity identity reference materials are creatively and successfully collected and retained for emergency use, and wherein appealing aesthetics render prominent display of the completed craft desirable, thereby encouraging visible storage, and thereby facilitating quick and easy access thereto, if necessary. The present invention is particularly suitable for use as a child's craft, however, may be utilized as a means of collecting and storing identity reference materials for any individual of any age.

### BACKGROUND OF THE INVENTION

Unfortunately, each day more children are reported missing. While many are subjected to abduction by a non-custodial parent and may not be placed in immediate threat of harm, others are tragic victims of kidnapping and other violent crimes. As a result, parents typically educate themselves and their children in an effort to eliminate the likelihood of such a horrendous occurrence, and to prepare their child with at least a minimal skill set to hopefully aid in survival.

One known factor affecting the likelihood of the safe return of the child is the speed of apprehension, that is, the length of time that transpires before the child is located. In recognition of this, many, if not all States have enacted laws that create a statewide system of alerts advising the public in the case of child abduction. Such alerts have proven very successful, ostensibly providing law enforcement officials with vast public search teams, by way of every individual who becomes aware of such an alert. When a child is involved, thankfully, tipsters are eager to assist by reporting sightings.

Most times, the period immediately following the initial report to authorities by the victim's family is filled with overwhelming fear and shock, sometimes rendering the family members unsuitable as sources of helpful information. Unfortunately, it is during this initial period that distribution of information suitable for verifying the identity of the lost child can be critical. As a result, various methods and devices have been designed to facilitate the advance collection of such information, thereby ensuring its availability in the event of an emergency. Each such method and device, however, is disadvantageous in view of the present invention.

One common form of personal data that is collected for use as an identity reference source is fingerprints. Numerous types of fingerprint cards have been designed, including those designed with children in mind, wherein a school photo and other personal statistical information are included, in addition to inked fingerprints. Others have been configured with a self-contained design for compact packaging, to encourage consumer use. Each of these does effectively collect and store fingerprint data: however, in the absence of suitable fingerprint evidence for evaluation, such information disadvantageously remains essentially of no use.

Some DNA kits have focused on sample collection techniques, wherein adhesive sheets are utilized to collect epidermal cells. Numerous others rely on hair samples and other non-invasive collectables containing valuable cellular information. One type of kit includes collection swabs, wherein the cheek/gum area is swabbed, the swab is placed in a provided container, and the container is held in storage by the kit provider, possible in a collection drip-box, until such time as an emergency occurs, or until a predetermined date of destruction. Unfortunately, following the occurrence of a tragic emergency, the existence of the sample would first need to be discovered. Then, the sample location would need to be determined from the records of the kit provider. Each such step could add precious hours, or even days, onto the waiting period for answers.

In an attempt to alleviate these disadvantages, other kits have offered home-stored samplings. One such design is directed toward facilitating the home collection and self-storage of DNA reference material, wherein pre-designated receptacles are provided for hairs, swabs, and blood collection cards. Another includes essentially similar cellular collection materials, at in combination with fingerprints, a photo and other personal data, all packaged within a small container intended for frozen storage until use. Again, each of these provides vital information in the event of a need for forensic identification, but is disadvantageous in view of the present invention.

Small children may be reluctant to pay attention, or may find it disturbing to be asked, without a suitable context, to provide buccal swabbings or even fingerprints, wherein collection of such samples could potentially introduce the child to new, previously unrealized fears. Even more so, some children experience stress during collection of buccal cell and/or blood samples, and could additively experience fears of future dangers, given the nature of the typical collection experience.

Therefore, it is readily apparent that there is a need for a personal identification system and device, wherein identity reference materials are creatively and successfully collected and retained for emergency use, wherein a unique retention system facilitates quick and easy access thereto, and wherein collection of the identity materials is cleverly disguised as a fun craft project, thereby avoiding the above discussed disadvantages.

### BRIEF SUMMARY OF THE INVENTION

Briefly described, in a preferred embodiment, the present invention overcomes the above-mentioned disadvantages and meets the recognized need for such a device by providing a craft kit and personal identification system and device, wherein a pre-packaged craft provides a fun activity, wherein identity reference materials are creatively and successfully collected, and wherein appealing aesthetics render prominent display of the completed craft desirable.

According to its major aspects and broadly stated, in its preferred form, the present invention is a self-contained, artistically creative craft kit, wherein a child's fingerprints are incorporated into a base drawing and the drawing is personalized with the child's name, wherein a transparent box is initially utilized to contain the craft components and subsequently to perform as a display frame, wherein a ten-print fingerprint card is stored therein, and wherein DNA source material, in the form of a hair sample, is securely retained, along with personal data, and a photo, on an identification card also stored therein.

More specifically, the device of the present invention in its preferred form is a self-contained arts and crafts style kit packaged within a box-style acrylic frame. The preferred craft materials include a pre-inked stamp pad for fingerprint collection, a moist towelette for cleaning fingertips, a decorative-ink pen for personalization of the drawing with the child's name, and adhesive-backed magnets facilitating refrigerator display of the completed craft. Additionally, three cards are preferably included: 1) a display card depicting an exemplary completed craft, 2) a DNA Identification Card, 3) an instruction card with directions for completing the kit, 4) a blank colored angel to decorated and draw, whereon the final design will be completed via the addition of fingerprints and personalization with the child's name, and then displayed via the frame, 5) a black and white blank angel providing a practice work piece for the child, and 6) a ten-print fingerprint collection card.

Preferably, the base drawing is an angel, depicted in a traditionally gender-directed manner, via attire and coloration, wherein fingerprints are utilized to complete the angel's wings The addition of the child's name, along with the collection of the additional identification materials, creates a unique FINGER ANGEL artwork design suitable for display, with valuable identification source data compiled therewith, for a unique guardian angel benefit.

Thus, a feature and advantage of the present invention is its ability to be quickly and easily completed.

Another feature and advantage of the present invention is its ability to be inexpensively manufactured.

Yet another feature and advantage of the present invention is its ability to be easily accessed in the event of emergency.

Still yet another feature and advantage of the present invention is its ability to define a fun project for kids, while coincidently gathering potentially critical identification data.

Still yet another feature and advantage of the present invention is its ability to define a self-contained craft kit pre-packaged within a display frame.

Yet another feature and advantage of the present invention is its ability to provide a collection technique and craft combination that is capable of completion essentially without the use of outside materials.

Yet still another feature and advantage of the present invention is its ability to provide a final craft work with an attractive and aesthetically desirable appearance.

These and other features and advantages of the invention will become more apparent to one skilled in the art from the following description and claims when read in light of the accompanying drawings.

### DETAILED DESCRIPTION OF THE PREFERRED AND ALTERNATE EMBODIMENTS

In describing the preferred and alternate embodiments of the present invention, as illustrated in the figures and/or described herein, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-13, the present invention in the preferred embodiment is craft kit and personal identification system and device 10, wherein preferred self-contained arts and crafts style kit package 12 comprises box-style flame 20, storage box/display frame support member 30, plurality of craft materials 50, DNA identification card 70, practice artwork card 90, instruction card 92, fingerprint chart 110 and, FINGER ANGEL art 117.

In the preferred embodiment, box-style frame 20 is formed from acrylic, or other suitably transparent material, wherein preferably, box-style frame 20 is defined by display surface 22 and peripheral walls 24a-d. Although it is preferred that box-style frame 20 is fully transparent, peripheral walls 24a-d could be opaque, or non-transparent, and display wall 22 could have non-transparent features, such as decorative artwork, framing or etch work provided thereon. Preferably, peripheral walls 24a and 24c have tabs 26a and 26c defined thereon, wherein tabs 26a and 26c function to retain storage box/display frame support member 30 within box-style frame 20. One skilled in the art would readily recognize that tabs 26a and 26c could be alternately positioned and/or alternately configured, could be positioned on peripheral walls 24b and 24d, and/or could be positioned on all peripheral walls 24a-24d. Further, although it is preferred that box-style frame 20 be formed without a rear wall, box-style frame 20 could be alternately configured as an operable box, such as with at least one removable or hinge able panel. However, given the ultimate preferred storage goal of craft kit and personal identification system and device 10 of providing a creative and effective storage solution for individual identification reference materials, such as cellular materials with DNA, it is preferred that box-style frame 20 remain configured in such a manner as to allow some passage of air, thereby inhibiting potentially enhanced degradation via storage of samples in sealed, potentially humid plastics, especially at room temperatures.

Preferably, storage box/display frame support member 30, best seen in FIG. 12, is formed from sturdy, yet thin and lightweight paperboard materials, although other materials could be utilized, including, for exemplary purposes only, plastic, cardboard, and/or balsa wood. Again, in order to maximize the lifespan of the cellular samples collected and stored therein, it is preferred that storage box/display frame support member 30 be formed from materials with at least minimal breathe-ability, wherein detrimental growth commonly occurring in sealed plastic biological specimens can be minimized via the possibility of at least some air circulation through storage container walls.

Preferably, storage box/display frame support member 30 defines inner box 32, for containment of plurality of craft materials 50. Preferably, storage box/display frame support member 30 is dimensioned for a snug fit within box-style frame 20, with tabs 24b and 24d securely, yet removable, retaining storage box/display frame support member 30 within box-style frame 20. Preferably, the depth of inner box 32 supports the completed formal artwork card 110 essentially flush against display wall 22 following completion of the craft. Also, preferably adapted with perforated hanging aperture 36 and with perforated, extendable stand 38, thereby facilitating a variety of display options for the completed craft.

Referring one to FIG. 1, preferred plurality of craft materials 50 preferably comprises pre-inked stamp pad 52, cleansing cloth 54, personalization tool 56, and magnetic display adapters 58. One skilled in the art would readily recognize that other craft materials could be included without departing from the intended scope of the present invention, such as, for exemplary purposes only, glitter, sequins, stencils, templates and/or any other suitable craft component. Further, although pre-inked stamp pad 52 is preferred, in an alternate embodiment, a dry chemical pad (not shown) could be provided, wherein formal artwork card 110 could be appropriately impregnated with developmental chemicals, eliminating the need for wet ink. Additionally, although it is preferred that personalization tool 56 is a glitter gel pen 57, other appropriate tools could be added or substituted, such as, for exemplary purposes only, colored pencils, metallic ink pens, and/or acrylic craft paint.

Plurality of craft materials 50 enable craft kit and personal identification system and device 10 to be created, essentially without requiring the use of any other tools or materials. Preferably, three cards, 70,90 and 110, are provided, wherein each requires different input and stimulates a unique activity.

The DNA identification card 70 preferably displays an assimilation surface 74. Preferred display surface 72 includes a sample of a completed drawing 117 from a kit 12. Also, preferably, plurality of personal data and characteristic input blanks 76 are printed on a DNA data assimilation surface 74, wherein data inquiries may include, but not be limited to, name, birth date, height, weight, hair color, eye color, unique characteristics, such as scars, birthmarks, or the like, physician contact information, and special medical needs. One skilled in the art would readily recognize that any appropriate data inquiry could be included on DNA data assimilation surface 74 in addition to, or in lieu of, those depicted and described herein, without departing from the intended scope of the present invention.

Additionally, and also preferably, DNA data assimilation surface 74 further defines photo port 77 and DNA sample port 78. Photo port 77 is preferably dimensioned to receive a traditionally sized school photo. DNA sample port 78 is preferably sized to receive a plurality of hair strands, including the root or a nail clipping, to serve as a DNA reference standard, if necessary. Although it is preferred that photos, hair samples and nail clippings are secured to DNA identification card 70 via adhesive tape provided by the user, in an alternate embodiment, exposable adhesive could be provided on photo port 77 and/or sample port 8, or double-sided or single-sided tape strips could be provided within kit 12 for such use.

Instruction card 90 preferably includes instruction surface 92. Preferably, instruction surface 92 includes printed instructions for the completion of kit 12. FIG. 10 AND FIG. 11 include practice artwork surface 94, to which is essential to drawing the formal 110, to enable the user to practice applying fingerprints in the appropriate location, wherein in the preferred sample of completed formal drawing 110 from kit 12, drawing 96 is an angel and the fingerprints are to be applied to form the angel's wings.

Now referring to FIG. 8, fingerprint collection card 110 preferably includes a ten-print collection card surface 114.

FIG. 5 depicts the male version, and wherein FIG. 4 depicts the female version, and wherein in each, fingerprints are utilized to complete the angel's wings. Preferably, the name of the child completing the kit is added in space 117, via personalization tool 56, in order to create a unique FINGER ANGEL artwork design suitable for display, with valuable fingerprint data compiled and displayed therewith.

Preferably, each card, 70, 90 and 110 is dimensioned to fit within peripheral walls 24a-24d of box-style frame 20. Thus, in the preferred assembly for distribution of craft kit and personal identification system and device 10, combination display card/DNA identification card 70 is positioned proximate display surface 22 of box-style frame 20, with display surface 72 visible through display surface 22. Preferably, formal artwork card, fingerprint collection card 110 and plurality of craft materials 50 are secured within storage box/display frame support member 30, wherein storage box/display frame support member 30 is preferably positioned in box-style frame 20, and while instruction card and practice artwork card 90 is positioned on rear surface 34 of inner box 32, with instruction card surface 92 outwardly displayed. Arranged in such a preferred manner, craft kit and personal identification system and devise 10 is able to be shrink-wrapped for presentation in a display.

In the preferred use, outer wrapping is removed from craft kit and personal identification system and device 10, and inner ox 32 is remove, along with display card and DNA identification card 70 and instruction card and practice artwork card 90. Plurality of craft materials 50 are then preferably removed form inner box 32, along with combination formal artwork card 117/fingerprint collection card 110. Preferably, pre-inked pad 52 is utilized to practice fingerprint collection and placement techniques on practice artwork card 90, and thereafter to place fingerprints on both sides of formal artwork card 117 and fingerprint collection card 10. Cleansing cloth 54 is utilized to remove ink from fingertips. Thereafter, personalization tool 56 is preferably utilize to add the name of the child to personalization area 117. Pen 57 is further utilized to complete data entry on DNA identification card 70, and a hair sample is collected from the child and placed, along with a photo, preferably on DNA identification card 70. Formal artwork card 110 is preferably positioned, with the FINGER ANGEL proximate display surface 112. All remaining components are preferably stored within storage box/display frame support member 30, preferably secured within box-style frame 20. The completed craft 12 may then be hung on a hook or nail via hanging aperture 36, may be free-standing via perforated, extendable stand 38, or may be adapted with magnets 58 for placement on a refrigerator door, as preferred by the user.

Although preferably, box-style frame 20 is a 4×6 inch plastic frame, other dimensions could be utilized, as desired, wherein larger FINGER ANGELS could be depicted.

In another alternate embodiment, alternate designs could be utilized, in addition to or in lieu of an angel, wherein other components could be defined by fingerprints other than angel's wings.

In yet another alternate embodiment, removable adhesives could be provided, enabling secure, yet removable hanging of completed kit 12 on any surface, irrespective of magnetic properties.

In still another alternate embodiment, photo port 77 could include a transparent plastic sleeve for receiving and retaining a photo therein.

In yet another alternate embodiment, DNA standard port 78 could include an envelope, or sleeve style receptacle, preferably formed of at least minimally breathable materials, or plastic; however, sealing plastic would be least desirable given potential biological degradation issues.

In still yet another alternate embodiment, kit 12 could include a swab for collecting buccal cells, and DNA standard port 78 could include an appropriately configured swab receptacle.

In still yet another alternate embodiment, kit 12 could include a blot pad, or other suitably absorbent blood collection tool, wherein blood could be collected if a child bleeds from an accidental scrape or tooth loss, and such collected blood be retained for use as a DNA standard.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is an overhead view of a craft kit and personal identification system and device, according to the preferred embodiment of the present invention, showing the preferred packaging and craft components;

FIG. 2 is a plan view of the craft kit and personal identification system of FIG. 1, depicting a female angel;

FIG. 3 is a plan view of the craft kit and personal identification system of FIG. 1, depicting a male angel;

FIG. 4 is a plan view of the finger angel art, depicting a female angel, used as the creative project for the child to enjoy in the personal identification system of FIG. 1;

FIG. 5 is a plan view of the finger angel art, depicting a male angel, used as the creative project for the child to enjoy in the personal identification system of FIG. 1;

FIG. 6 is a plan view of the DNA ID card used inside the female-style angel kit, whereas, data is collected and stored inside the personal identification system of FIG. 1;

FIG. 7 is a plan view of the DNA ID card used inside the male-style angel kit, whereas, data is collected and stored inside the personal identification system of FIG. 1;

FIG. 8 is a plan view of a fingerprint chart included inside each personal identification system of FIG. 1;

FIG. 9 is a plan view of an instruction card included inside each personal identification system of FIG. 1;

FIG. 10 is a plan view of a blank angel for practice of the child's finger, depicting a female angel included inside the personal identification system of FIG. 1;

FIG. 11 is a plan view of a blank angel for practice of the child's finger, depicting a male angel included inside the personal identification system of FIG. 1;

FIG. 12 is a plan view of an outer surface of an inner box for the craft kit and personal identification system of FIG. 1, showing preferred frame support adaptations;

FIG. 13 is a plan view of a craft kit and personal identification system, according to an alternate embodiment of the present invention, showing an alternate female base drawing; and

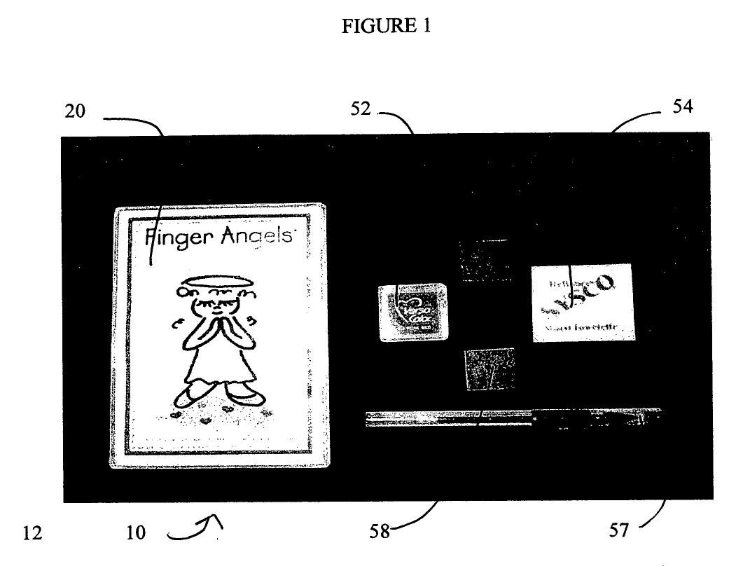

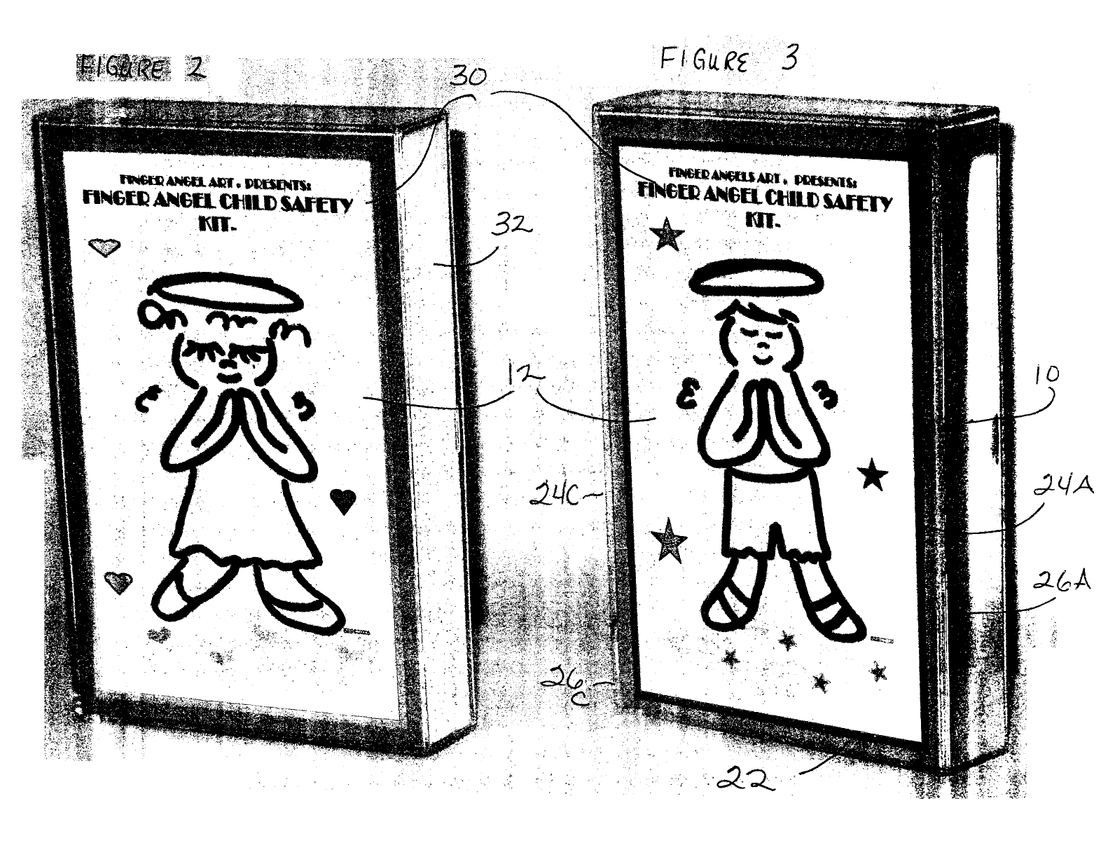

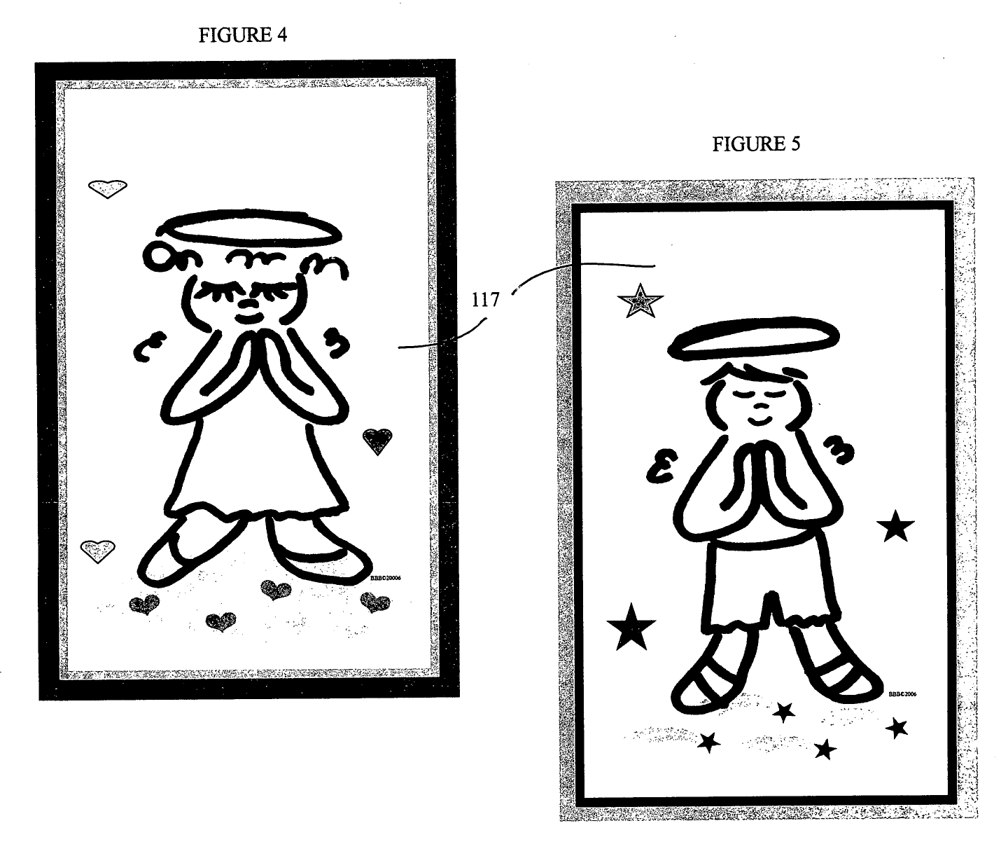

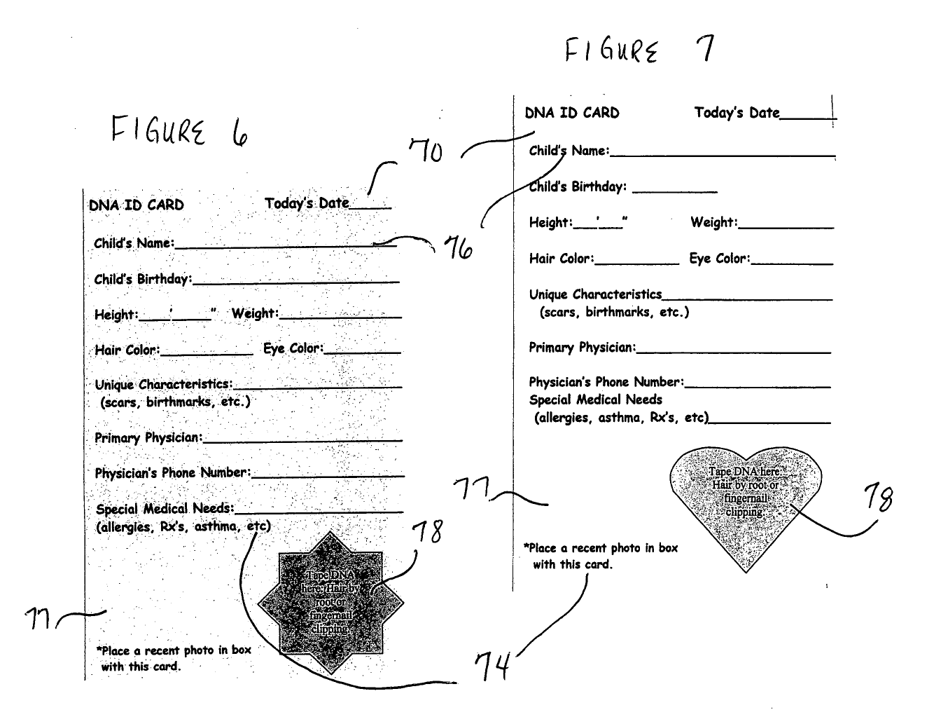

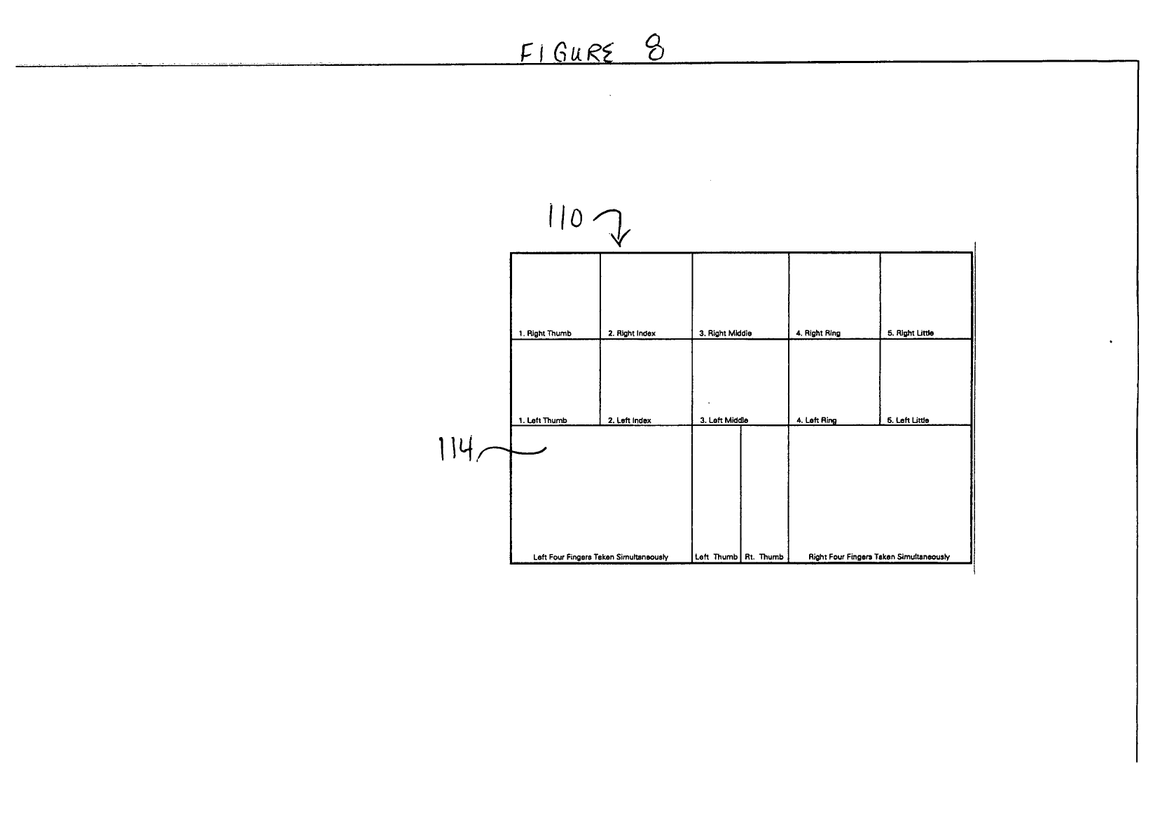

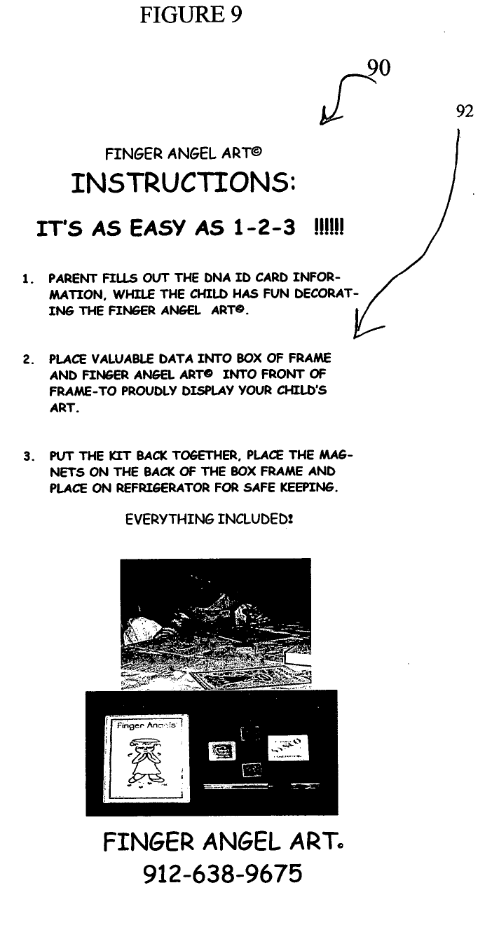

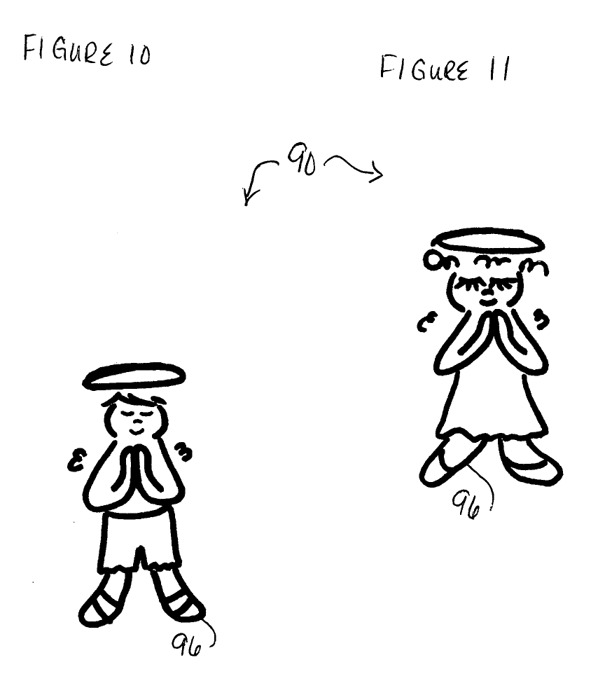

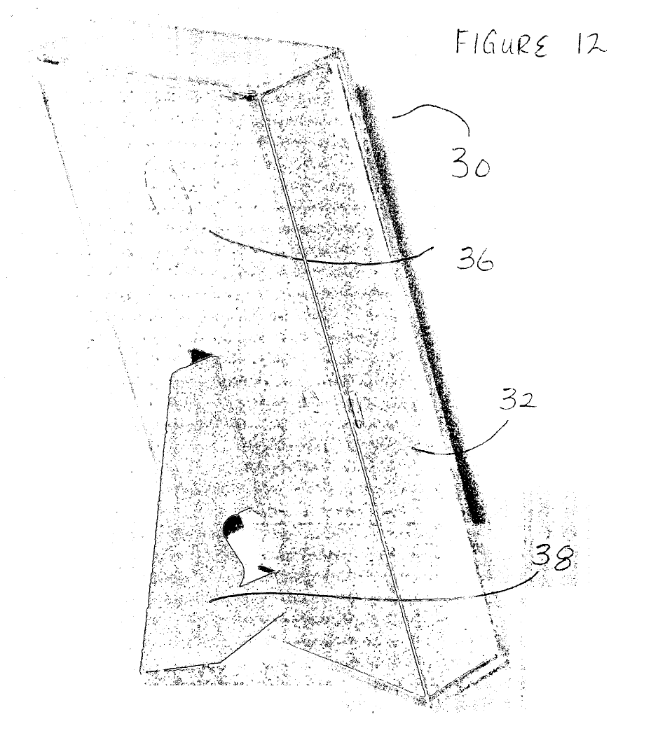

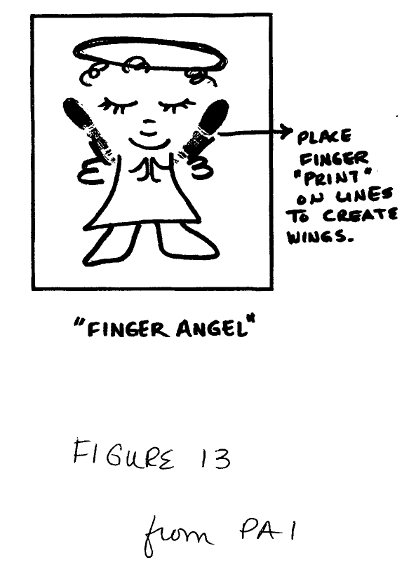

I claim:

1. A craft kit and personal identification system and device, comprising:
a transparent, box-style flame;
a storage ox adapted to fit within said frame and adapted with frame display members;
a plurality of craft materials;
a card member with a drawing depicted thereon, said drawing comprising an incomplete base drawing capable of completion via the addition of a plurality of fingerprints.

2. The craft kit of claim 1, further comprising a DNA identification card imprinted with DNA identification data inquiries, and adapted to receive a DNA standard sample.

3. The craft kit of claim 1, wherein said plurality of craft materials comprises an ink pad, a gel pen, a cleansing cloth, and a magnet.

4. The craft kit of claim 1, further comprising an instruction card, a practice artwork card and a fingerprint collection card.
